(19) United States
(12) Patent Application Publication
(10) Pub. No.: US 2002/0026590 A1
(43) Pub. Date: Feb. 28, 2002

(54) System for authenticating access to a network, storage medium, program and method for authenticating access to a network

(76) Inventor: Masanori Kusunoki, Tokyo (JP)

Correspondence Address: Cooper & Dunham LLP, 1185 Avenue of the Americas, New York, NY, 10036, US

(21) Appl. No.: 09/805,284

(22) Filed: Mar. 13, 2001

(30) Foreign Application Priority Data
Mar. 13, 2000 (JP) 2000-069079
Mar. 6, 2001 (JP) 2001-061999

(51) Int. Cl. H04L 9/00; H04L 9/32; G06F 11/30

(52) U.S. Cl. 713/201

(57) ABSTRACT

The present invention comprises a first authentication server for determining whether or not a client terminal should be connected to a first terminal server, on the basis of personal information input from the client terminal, creating first ticket data by encoding a client parameter, and transferring the first ticket data to the second terminal server, and a second authentication server for detecting whether or not the client parameter is valid and whether or not the first ticket data has been used, creating second ticket data by encoding the client parameter, comparing the first and second ticket data, and supplying the second terminal server with data indicative of whether or not the second terminal server should be connected to the client.

### CROSS-REFERENCE TO RELATED APPLICATIONS

This application is based upon and claims the benefit of priority from the prior Japanese Patent Applications No. 2000-069079, Mar. 13, 2000; and No. 2001-061999, Mar. 6, 2001, the entire contents of which are incorporated herein by reference.

### BACKGROUND OF THE INVENTION

The present invention relates to an access authentication system and an access authentication method for allowing the user, who has a right of access to a predetermined application provider, to access another application provider.

The user can use service providers for providing a variety of services, such as information services, via the Internet. The service providers indicate agencies for providing data, contents and information processing services, etc. to client terminals connected thereto via the Internet. These service providers are independent of each other, and the user can enter into a contract with any of them and obtain ID information and a password for accessing thereto.

However, it is troublesome for the user to make a contract with many service providers since they must manage many ID information items and passwords corresponding to the providers. Further, each service provider can provide only a limited number of services.

On the other hand, it is considered to employ a method for allowing the user to use a common password and ID information item for a plurality of service providers. This method, however, is disadvantageous in terms of accounting or security since all service providers, with which the user makes a contract, manage the same ID information and password of the user.

### BRIEF SUMMARY OF THE INVENTION

It is the object of the invention to allow the user, who has personal information (ID information and a password) for one server (service provider), to use other providers (service providers) for providing a variety of services, without disclosing all of their personal information.

The present invention provides an access authentication system for providing a client with a service of connection to a second terminal server via a first terminal server, characterized by comprising: a first authentication server for determining whether or not the client should be connected to the first terminal server, on the basis of personal information input by the client to the first terminal server, the first authentication server creating first ticket data by encoding a client parameter, which includes part of the personal information, on the basis of a predetermined formula, and transferring the first ticket data to the second terminal server; and a second authentication server for detecting whether or not the client parameter is valid and whether or not the first ticket data has been used, creating second ticket data by encoding the client parameter on the basis of a predetermined formula, comparing the first and second ticket data, and supplying the second terminal server with data indicative of whether or not the second terminal server should be connected to the client.

The present invention enables a client, who has personal information (ID information and a password) for one server (service provider), to use other providers (service providers) for providing a variety of services, without disclosing all of their personal information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a view illustrating the structure of an access authentication system according to the embodiment of the invention;

FIG. 2A is a block diagram illustrating the structure of an authentication server incorporated in the access authentication system;

FIG. 2B is a block diagram illustrating the structure of another authentication server incorporated in the access authentication system; and

FIG. 3 is a flowchart useful in explaining the operation of the access authentication system.

The accompanying drawings, which are incorporated in and constitute a part of the specification, illustrate presently preferred embodiments of the invention, and together with the general description given above and the detailed description of the preferred embodiments given below, serve to explain the principles of the invention.

### DETAILED DESCRIPTION OF THE INVENTION

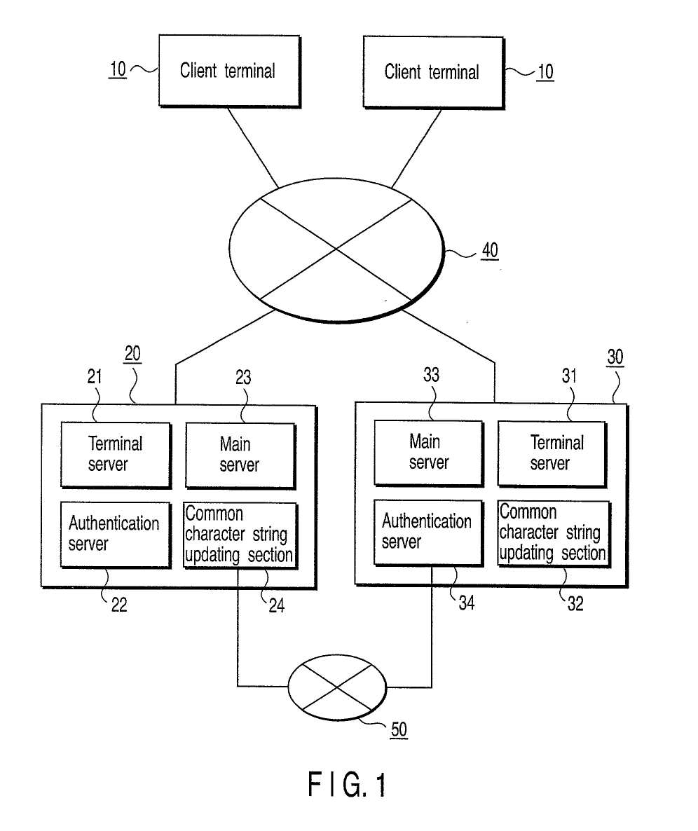

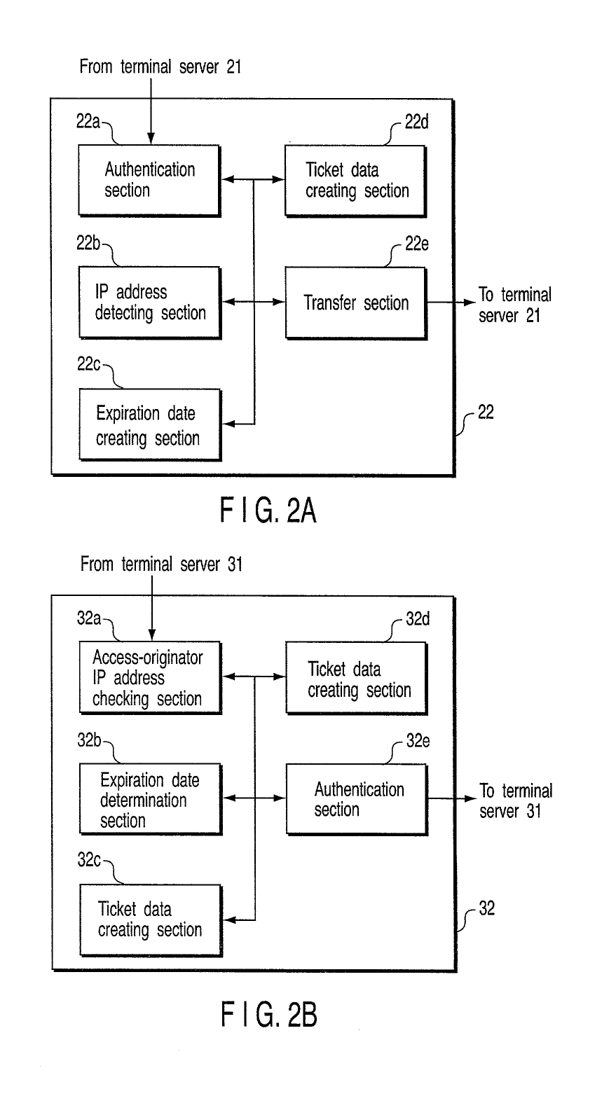

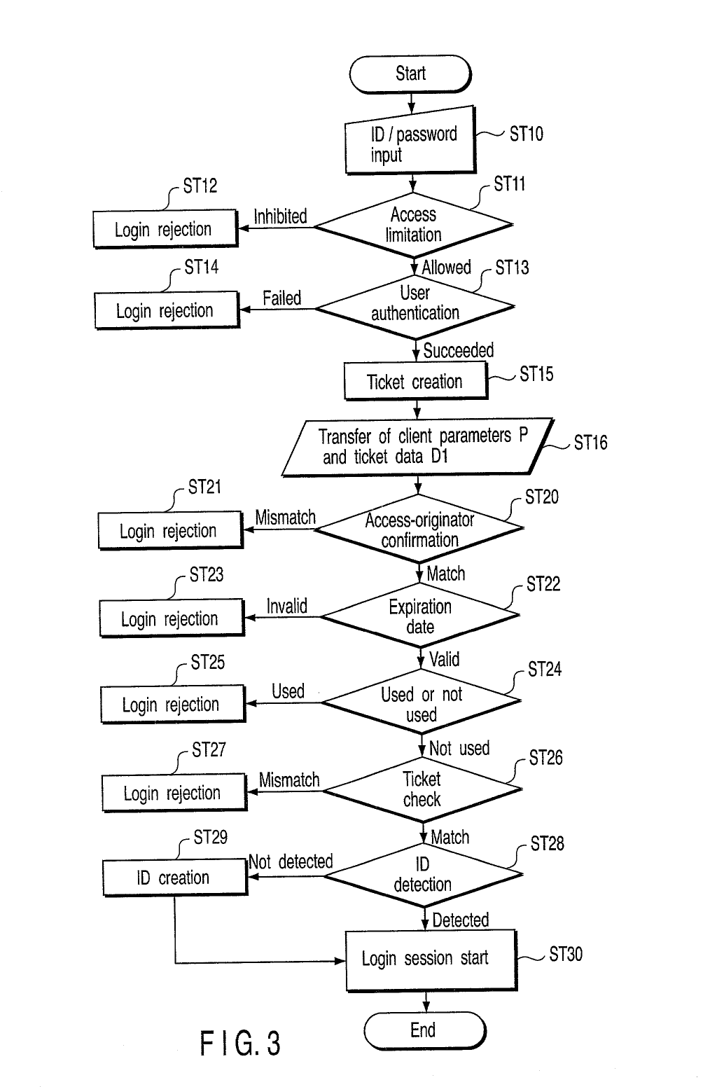

FIG. 1 is a view illustrating the structure of an access authentication system according to the embodiment of the invention, FIG. 2A is a block diagram illustrating the structure of an authentication server 22 incorporated in the access authentication system, FIG. 2B is a block diagram illustrating the structure of an authentication server 32 incorporated in the access authentication system, and FIG. 3 is a flowchart useful in explaining the procedure of access authentication. This embodiment includes a case where the system is realized by a software process.

In FIG. 1, reference numeral 10 denotes a user or client terminal, 20 a service provider for relaying a service, with which the user has a contract, 30 a service provider for providing a service, with which the user does not have a contract, 40 the Internet line, and 50 a telephone line.

The service-relaying service provider 20 comprises a terminal server (first terminal server) 21 connected to the Internet line 40, an authentication server (first authentication server) 22 connected to the terminal server 21 for executing, for example, authentication described later, a main server 23 connected to the terminal server 22 for providing an information service, and a common character string updating section 24 connected to the telephone line 50.

The authentication server 22 includes: an authentication section 22a for determining whether or not the client terminal 10 should be connected to the first terminal server 21, on the basis of ID information and a password input to the terminal server 21 from the client terminal 10; an IP address detecting section 22b for detecting an access-originator IP address assigned to the client terminal 10; an expiration date creating section 22c for creating the expiration date of a first ticket (first ticket data) described later; a ticket data creating section 22d for creating first ticket data D1, using a predetermined formula such as summarization based on a one-way function, on the basis of client parameters P, i.e. the ID information, the access-originator IP address of the client, the expiration date created by the expiration date creating section 22c, and a common character string updated by the common character string updating section 24, etc.; and a transfer section 22e for transferring the client parameters P and the first ticket data to the authentication server 32 via the Internet line 40 and the terminal server 31.

The service-providing service provider 30 includes the terminal server (second terminal server) 31 connected to the Internet line 40, the authentication server (second authentication server) 32 connected to the terminal server 31 for executing, for example, authentication as described later, a main server 33 connected to the terminal server 31 for providing an information service, and a common character string updating section 34 connected to the telephone line 50.

The authentication server 32 includes: an access-originator IP address checking section 32a for checking the access-originator IP address input from the client terminal 10 to the client server 31, against the access-originator IP address included in the client parameters P transferred from the authentication server 22; an expiration date determination section 32b for determining whether or not access has been executed on or before the expiration date; a ticket use determination section 32c for determining whether or not the first ticket data D1 has been used; a ticket data creating section 32d for creating second ticket data D2 by encoding the transferred client parameters P using the aforementioned formula; and an authentication section 32e for checking the second ticket data D2 against the first ticket data D1 to thereby determine whether or not the client terminal 10 should be connected to the second terminal server 31.

The common character string updating sections 24 and 34 store the same common character string consisting of characters, and periodically update it.

In the above structure, the user accesses the main server 33 from the client terminal 10 as follows: First, the user tries to access the terminal server 21 from the client terminal 10 via the Internet line 40. At this time, the user inputs their ID information and password on a login screen provided by the service-relaying service provider (step ST10). Then, the terminal server 21 executes optionally-set access limitation (step ST11). If the access by the user is not allowed, login is rejected (step ST12).

If the access is allowed at the step ST12, the ID information, the password and the access-originator IP address of the user are transmitted to the authentication server 22. In the authentication section 22a, user authentication is executed on the basis of the ID information and password (step ST13). If these information items are not authenticated, login is rejected (step ST14). At this time, access to the main server 23 is allowed.

If the information items are authenticated in the step ST4, the IP address detecting section 22b detects the access-originator IP address of the client terminal 10, and the expiration date creating section 22c creates the expiration date of the first ticket data D1. The ticket data creating section 22d summarizes the client parameters P (the ID information, the access-originator IP address, the expiration date and the common character string), using the one-way function, thereby creating the first ticket data D1 (step ST15).

Thereafter, the transfer section 22e transfers the client parameters P and the first ticket data D1 to the authentication server 32 via the Internet line 40 and the terminal server 31 (step ST16).

In the authentication section 32 of the service-providing service provider 30, the access-originator IP address checking section 32a checks the access-originator IP address input from the client terminal 10 to the terminal server 31, against the access-originator IP address included in the client parameters P transferred from the authentication server 22 (step ST20). If they do not correspond to each other, login is rejected (step ST21).

Subsequently, the expiration date determination section 32b determines whether or not the access has been executed on or before the expiration date (step ST22). If it has been executed after the expiration date, the access is determined to be invalid and login is rejected (step ST23).

Then, the ticket use determination section 32c determines whether or not the first ticket data D1 has been used (step ST24). If it has already been used, login is rejected (step ST25).

Thereafter, the ticket data creating section 32d creates the second ticket data D2 by summarizing the transferred client parameters P using the one-way function, and checks the first ticket data D1 against the second ticket data D2 (step ST26). If they do not correspond to each other, login is rejected (step ST27).

After that, it is determined whether or not ID information is already registered (step ST28). If it is registered, the program proceeds to a step ST30, whereas if it is not registered, ID information is created (step ST29). As a result, login to the main server 33 is allowed (step ST30).

Even if, in the above-described access authentication system, the client parameters P are intercepted by some means while they are being transferred from the service-relaying service provider 20 to the service-providing service provider 30, and attempted alteration is performed on them for erroneous access, login is rejected since the first ticket data D1 does not correspond to second ticket data D2 created on the basis of the altered client parameters P.

The creation of the first ticket data D1 on the basis of the altered client parameters P also enables login to the service-providing service provider 30. Although it is necessary to detect a common character string in order to create the first ticket data D1, the common character string may be obtained by forcibly entering the authentication server 22 or 32, performing a looped trial-and-error, or performing a reverse calculation based on the one-way function. However, the updating of the common character string in a sufficiently short time enables the detection of the common character string to be made difficult.

Moreover, even if appropriation of the client parameters P and the first ticket data D1 is attempted, if the term of validity is set sufficiently short, it is very possible that access will be executed after the validity term and hence login will be rejected.

In addition, within the validity term, a legitimate user accesses the service-providing service provider 30 substantially at the same time as accessing the service-relaying service provider 20. Accordingly, even if a third person tries to illegally appropriate and use the client parameters P and the first ticket data D1, they can do so always after the legitimate user uses the first ticket data D1. This means that the third person cannot execute login using the first ticket data D1.

On the other hand, the problem may arise. When a legitimate user transmits the first ticket data D1 containing a common character string to the service-providing service provider 30, the common character string is already updated and hence the first ticket data D1 comes to be different from the second ticket data D2, which means that login by the legitimate user is rejected. This can be solved in the following manner.

Suppose that the common character string is periodically changed in the order of, for example, A, B, C and D strings. In this case, two types of first ticket data D1 are created which have respective common character strings such as A and B strings, B and C strings, or C and D strings, etc. If one of the two types of first ticket data D1 corresponds to the second ticket data D2, login is allowed.

As described above, in the access authentication system according to the embodiment of the invention, the client, who has a contract with one service provider (service-relaying service provider), can use another service provider (service-providing service provider) for providing a variety of services via the first-mentioned service provider, with their password and ID information input only to the first-mentioned service provider. Further, even when data to be transferred from the service-relaying service provider to the service-providing service provider is appropriated by a third person, the service-providing service provider is prevented from being illegally accessed, since many security measures are adopted.

The above-described system may be realized by a program installed in each server computer. Further, part of each process may be realized by an operation system or a middleware, etc. that operates in each computer on the basis of a program.

Furthermore, such a program may be stored in a computer-readable storage medium. The computer-readable program-storage medium includes a magnetic disk, a floppy disk, a hard disk, an optical disk (DC-ROM, CR-R, DVD, etc.), MO and a semiconductor memory, etc.

In addition, programs may be transmitted via a LAN or the Internet, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An access authentication system for providing a client with a service of connection to a second terminal server via a first terminal server, characterized by comprising:
a first authentication server for determining whether or not the client should be connected to the first terminal server, on the basis of personal information input by the client to the first terminal server, the first authentication server creating first ticket data by encoding a client parameter, which includes part of the personal information, on the basis of a predetermined formula, and transferring the first ticket data to the second terminal server; and
a second authentication server for detecting whether or not the client parameter is valid and whether or not the first ticket data has been used, creating second ticket data by encoding the client parameter on the basis of a predetermined formula, comparing the first and second ticket data, and supplying the second terminal server with data indicative of whether or not the second terminal server should be connected to the client.

2. The access authentication system according to claim 1, characterized in that the predetermined formula is summarization using a one-way function.

3. The access authentication system according to claim 1, characterized in that the client parameter includes at least one of ID information of the client, an access-originator IP address and an expiration date set for the first ticket data.

4. The access authentication system according to claim 1, characterized in that the first and second authentication servers include a predetermined common character string in the first and second ticket data, respectively.

5. The access authentication system according to claim 4, characterized in that the common character string is changed at a predetermined point in time.

6. An access authentication system for providing a client with a service of connection to a second terminal server via a first terminal server, characterized by comprising:
a first authentication server for determining whether or not the client should be connected to the first terminal server, on the basis of ID information and a password input by the client to the first terminal server, the first authentication server creating first ticket data by encoding client parameters, which include the ID information, an access-originator IP address of the client, a predetermined expiration date and a common character string, on the basis of a predetermined formula, and transferring the first ticket data to the second terminal server; and
a second authentication server for comparing an access-originator IP address input by the client to the second terminal server with the access-originator IP address of the client included in the client parameter, thereby determining whether or not access by the client has been executed on or before the expiration date, determining whether or not the first ticket data has been used, creating second ticket data by encoding the client parameters on the basis of a predetermined formula, comparing the first and second ticket data, and supplying the second terminal server with data indicative of whether or not the second terminal server should be connected to the client.

7. An access authentication system for providing a client with a service of connection to a second terminal server via a first terminal server, characterized by comprising:
first personal information acquiring means for acquiring personal information input by the client to the first terminal server;
first authentication means for determining whether or not the client should be connected to the first terminal server, on the basis of the personal information;
first ticket data creating means for creating first ticket data by encoding a client parameter, which includes part of the personal information, on the basis of a predetermined formula;
transfer means for transferring data to the second terminal server;
second personal information acquiring means for acquiring personal information input by the client to the second terminal server; and
second authentication means for creating second ticket data by encoding the client parameter, which contains the part of the personal information, on the basis of a predetermined formula, comparing the first and second ticket data, and supplying the second terminal server with data indicative of whether or not the second terminal server should be connected to the client.

8. The access authentication system according to claim 7, characterized in that the predetermined formula is summarization using a one-way function.

9. The access authentication system according to claim 7, characterized in that the first and second ticket creating means include a predetermined common character string in the first and second ticket data, respectively.

10. The access authentication system according to claim 7, characterized in that the second authentication means judges validity of the first ticket data.

11. The access authentication system according to claim 7, characterized in that the second authentication means judges legality of the client parameter.

12. An access authentication system for providing a client with a service of connection via a first terminal server, characterized by comprising:
first personal information acquiring means for acquiring personal information from the client;
first authentication means for determining whether or not the client should be connected to the first terminal server, on the basis of the personal information;
first ticket data creating means for creating first ticket data by encoding a client parameter, which includes at least part of the personal information, on the basis of a predetermined formula if the first authentication means determines that the client should be connected to the first terminal server; and
transfer means for transferring the first ticket data.

13. An access authentication system for providing a client with a service of connection to a second terminal server, characterized by comprising:
first ticket data acquiring means for acquiring first ticket data created by encoding a client parameter, which includes part of personal information of the client, on the basis of a predetermined formula;
second personal information acquiring means for acquiring personal information from the client;
second ticket creating means for creating second ticket data by encoding a client parameter, which includes part of personal information acquired by the second personal information acquiring means, on the basis of a predetermined formula; and
judging means for comparing the first and second ticket data, and judging whether or not the client should be connected to the second terminal server.

14. A computer-readable storage medium that stores a program for operating a computer, the program being characterized by comprising:
first personal information acquiring means for acquiring personal information from a client in a first terminal server;
first authentication means for determining whether or not the client should be connected to the first terminal server, on the basis of the personal information;
first ticket data creating means for creating first ticket data by encoding a client parameter, which includes at least part of the personal information, on the basis of a predetermined formula if the first authentication means determines that the client should be connected to the first terminal server;
transfer means for transferring the first ticket data to a second terminal server;
first ticket data acquiring means for acquiring the first ticket data in the second terminal server;
second personal information acquiring means for acquiring personal information from the client in the second terminal server;
second ticket creating means for creating second ticket data by encoding a client parameter, which includes part of personal information, on the basis of the predetermined formula; and
second authentication means for comparing the first and second ticket data, thereby determining whether or not the client should be connected to the second terminal server.

15. A computer-readable storage medium that stores a program for operating a computer, the program being characterized by comprising:
first personal information acquiring means for acquiring personal information from the client in a first terminal server;
first authentication means for determining whether or not the client should be connected to the first terminal server, on the basis of the personal information;
first ticket data creating means for creating first ticket data by encoding a client parameter, which includes at least part of the personal information, on the basis of a predetermined formula if the first authentication means determines that the client should be connected to the first terminal server; and
transfer means for transferring the first ticket data.

16. A computer-readable storage medium that stores a program for operating a computer, the program being characterized by comprising:
first ticket data acquiring means for acquiring first ticket data created by encoding a client parameter, which includes part of personal information of the client, on the basis of a predetermined formula in a second terminal server;
second personal information acquiring means for acquiring personal information from the client in the second terminal server;
second ticket creating means for creating second ticket data by encoding a client parameter, which includes part of the personal information, on the basis of the predetermined formula; and
second authentication means for comparing the first and second ticket data, thereby determining whether or not the client should be connected to the second terminal server.

17. A program for operating a computer, comprising:
first personal information acquiring means for acquiring personal information from a client in a first terminal server;
first authentication means for determining whether or not the client should be connected to the first terminal server, on the basis of the personal information;
first ticket data creating means for creating first ticket data by encoding a client parameter, which includes at least part of the personal information, on the basis of a predetermined formula if the first authentication means determines that the client should be connected to the first terminal server;
transfer means for transferring the first ticket data to a second terminal server;
first ticket data acquiring means for acquiring the first ticket data in the second terminal server;
second personal information acquiring means for acquiring personal information from the client in the second terminal server;
second ticket creating means for creating second ticket data by encoding a client parameter, which includes part of personal information, on the basis of the predetermined formula; and
second authentication means for comparing the first and second ticket data, thereby determining whether or not the client should be connected to the second terminal server.

18. A program for operating a computer, comprising:
first personal information acquiring means for acquiring personal information from the client in a first terminal server;
first authentication means for determining whether or not the client should be connected to the first terminal server, on the basis of the personal information;
first ticket data creating means for creating first ticket data by encoding a client parameter, which includes at least part of the personal information, on the basis of a predetermined formula if the first authentication means determines that the client should be connected to the first terminal server; and
transfer means for transferring the first ticket data.

19. A program for operating a computer, comprising:
first ticket data acquiring means for acquiring first ticket data created by encoding a client parameter, which includes part of personal information of the client, on the basis of a predetermined formula in a second terminal server;
second personal information acquiring means for acquiring personal information from the client in the second terminal server;
second ticket creating means for creating second ticket data by encoding a client parameter, which includes part of the personal information, on the basis of the predetermined formula; and
second authentication means for comparing the first and second ticket data, thereby determining whether or not the client should be connected to the second terminal server.

20. An access authentication method for providing a client with a service of connection to a second terminal server via a first terminal server, characterized by comprising:
a first authentication step of determining whether or not the client should be connected to the first terminal server;
a first ticket data creating step of creating first ticket data by encoding a client parameter, which includes at least part of personal information input by the client, on the basis of a predetermined formula;
a data transfer step of transferring the client parameter and the first ticket data to the second terminal server;
a detection step of detecting whether or not the client parameter in the first terminal server is valid, and whether or not the first ticket data has been used;
a second ticket data creating step of creating a second ticket data by encoding the client parameter on the basis of a predetermined formula;
a ticket data comparison step of comparing the second ticket data with the first ticket data; and
a second authentication step of determining whether or not the client should be connected to the second terminal server, on the basis of results obtained at the determination step and the comparison step.
